(19) United States
(12) Patent Application Publication
(10) Pub. No.: US 2016/0257002 A1
(43) Pub. Date: Sep. 8, 2016

(54) ROBOT SYSTEM HAVING ROBOT OPERATED IN SYNCHRONIZATION WITH BENDING MACHINE

(71) Applicant: FANUC Corporation, Yamanashi (JP)

(72) Inventor: Yuusuke TAKAYAMA, Yamanashi (JP)

(21) Appl. No.: 15/055,724

(22) Filed: Feb. 29, 2016

(30) Foreign Application Priority Data
Mar. 6, 2015 (JP) 2015-044927

(51) Int. Cl. B25J 9/16; B21D 5/00; B25J 9/00

(52) U.S. Cl. CPC B25J 9/1664; B25J 9/0096; B21D 5/006

(57) ABSTRACT

A robot system for carrying out a bending process with respect to a workpiece held by a robot, in which an arc interpolation motion of the robot can be easily and precisely taught. A user coordinate system is set so as to specify a rotation axis of the bending motion in the bending process by inputting the position and/or angle of each axis of the robot to a teaching pendant by the operator. Next, in a teaching program of the robot, a process start position and an operation form are defined so as to add a bending process command, and a rotation angle of the bending process and an angular velocity of a command line about the rotation axis are designated. By virtue of this, an internal program for carrying out an arc interpolation motion by the robot is generated in a robot controlling part.

### BACKGROUND OF THE INVENTION

1. Field of the Invention

The present invention relates to a robot system for gripping a workpiece by using a robot and carrying out a bending process, while operating the robot in synchronization with a bending machine.

2. Description of the Related Art

Generally, in a bending machine such as a press brake, etc., the position and orientation (hereinafter, also referred to as position/orientation) of a workpiece are detected by a sensor, and a robot hand is moved to the detected position/orientation so as to grip and take out the workpiece. As a relevant prior art document, JP H06-015370 A discloses a method and a device, in which a trajectory for circular interpolation of the motion by a bending robot arranged on a bender is calculated so as to follow up the bending motion during a workpiece is gripped by a gripper of the robot, a thrust amount of a cutting edge of the bender corresponding to a bending angle by the circular interpolation, and the thrust amount of the bender is controlled corresponding to the motion of the bending robot.

JP 2009-154208 A discloses a bending method and device, in which (1) when a punch moved by an activated ram comes into contact with a workpiece held by a robot gripper, the workpiece is released from the robot gripper; (2) the robot gripper is moved so as to follow jumping-up action of the workpiece, and when the robot gripper is moved to a target angle position, the robot gripper stops and waits there; and (3) the ram reaches a limit position and stops there, and the ram is moved in the reverse direction after bending work is finished, and then, at the same time when the load of the workpiece becomes zero, the work piece is gripped by the robot gripper which is stopped at the target angle position.

Further, JP 2002-035843 A discloses a bending method and system, in which a butting device and a robot gripper are butted each other in both X- and Y-directions; X- and Y-coordinates of a butting reference position of the butting device and a robot reference position of the robot gripper are detected; a positional relationship between the X- and Y-coordinates of the butting reference position and the robot reference position is calculated; one of the coordinate systems of the butting reference position and the robot reference position is determined as a reference point, based on the calculated positional relationship; the X- and Y-coordinates of the other reference position are determined on the same coordinate system as the reference point; an operation program of the robot and an operation program of the butting device with respect to the reference point are generated; and a workpiece is bent by moving the robot and the butting device based on the respective operation programs.

Normally, in a bending process, one plate-like workpiece is bent through a plurality of process steps, in which a position of the workpiece to be processed is varied. Since the workpiece is bent so as to trace an arc by being supported by a processing knife as a fulcrum, it is necessary to teach at least three points in a motion program of a robot for gripping the workpiece, i.e., a start point, an end point and an intermediate point of the arc motion, and such teaching operation is cumbersome. Further, in case that an offline simulation is used, it is necessary to appropriately correct offline teaching contents when a teaching operation is carried out with respect to an actual workpiece.

On the other hand, in a method for gripping or releasing a workpiece by using a robot, it is necessary to adjust timings of releasing and gripping. In particular, when the workpiece is relatively large, the workpiece may be deflected by being released from the robot during the bending process, whereby processing quality of the workpiece may be deteriorated.

### SUMMARY OF THE INVENTION

An object of the present invention is to provide a robot system for carrying out a bending process with respect to a workpiece held by a robot, in which an arc interpolation motion of the robot can be easily and precisely taught.

The present invention provides a robot system comprising: a robot having a hand for holding a plate-like workpiece; and a bending machine for carrying out a bending process with respect to the workpiece while the workpiece is held by the hand, wherein a rotation axis of a bending motion in the bending process and a tool center point coordinate system of a front end of the robot are previously defined in a robot controller for controlling the robot, wherein, based on a taught process start point, a command line velocity and a command rotation angle, the robot controller moves the tool center point coordinate system from the process start point at the command line velocity about the rotation axis by the command rotation angle, and wherein the robot controller and a bender controller for controlling the bending machine match a timing of initiation of movement of the tool center point coordinate system and a timing of initiation of bending motion of the bending machine, so as to carry out a synchronous control between the robot and the bending machine.

The present invention also provides a robot system comprising: a robot having a hand for holding a plate-like workpiece; and a bending machine for carrying out a bending process with respect to the workpiece while the workpiece is held by the hand, wherein a rotation axis of a bending motion in the bending process and a tool center point coordinate system of a front end of the robot are previously defined in a robot controller for controlling the robot, wherein, based on a distance from the tool center point coordinate system at a process start point to the rotation axis, an inclination of the tool center point coordinate system, a command line velocity and a command rotation angle, the robot controller moves the tool center point coordinate system from the process start point at the command line velocity about the rotation axis by the command rotation angle, and wherein the robot controller and a bender controller for controlling the bending machine match a timing of initiation of movement of the tool center point coordinate system and a timing of initiation of bending motion of the bending machine, so as to carry out a synchronous control between the robot and the bending machine.

In a preferred embodiment, a distance from the tool center point coordinate system to the rotation axis and an angular component of a reference vector of the tool center point coordinate system are displayed in real-time or output to the outside as a signal in real-time, by the robot controller.

Further, the present invention provides a robot system comprising: a robot having a hand for holding a plate-like workpiece; and a bending machine for carrying out a bending process with respect to the workpiece while the workpiece is held by the hand, wherein a tool center point coordinate system of a front end of the robot is previously defined in a robot controller for controlling the robot, wherein, based on a taught process start point, a command line velocity, a command rotation angle, a distance from the tool center point coordinate system at the process start point to a rotation axis of a bending motion in the bending process and an inclination of the tool center point coordinate system, the robot controller moves the tool center point coordinate system from the process start point at the command line velocity about the rotation axis by the command rotation angle, and wherein the robot controller and a bender controller for controlling the bending machine match a timing of initiation of movement of the tool center point coordinate system and a timing of initiation of bending motion of the bending machine, so as to carry out a synchronous control between the robot and the bending machine.

In a preferred embodiment, a velocity transition of the robot during the bending process is stored as profile data, and the profile data is designated from a teaching program of the robot.

In a preferred embodiment, information on a velocity or an amount of movement of the bending machine is transmitted to the robot controller as an external signal, and the robot controller adjusts the velocity of the robot in real-time based on the external signal.

In a preferred embodiment, a motion component of the rotation axis in a movement direction thereof is added to an arc interpolation motion of the robot about the rotation axis.

In a preferred embodiment, the hand of the robot has an equalizing mechanism.

In a preferred embodiment, the robot has an additional axis used as a pressurized axis driving part of the bending machine.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a view showing a schematic configuration of a robot system according to a preferred embodiment of the present invention;

FIG. 2 is a view schematically showing a state in which a workpiece is bent by a bending machine;

FIG. 3 is a view showing a setting example of a user coordinate system and a tool center point coordinate system;

FIG. 4 is a view showing an example in which a condition for setting the user coordinate system is displayed on a screen of a robot teaching pendant;

FIG. 5 is a view showing an example of a teaching program of a robot;

FIG. 6 is a view showing an example of an internal program of the robot;

FIG. 7 is a view showing another setting example of a user coordinate system and a tool center point coordinate system;

FIG. 8 is a view showing another example of the teaching program of the robot;

FIG. 9 is a view showing an example in which the distance from the tool center point coordinate system to a rotation axis and an angular component of a reference vector of the tool center point coordinate system are displayed on the screen of the robot teaching pendant;

FIG. 10 is a view showing an example in which a target rotation angle about the rotation axis and a rotation angular velocity until reaching the target rotation angle are set as a profile;

FIG. 11 is a view showing another example of the teaching program of the robot;

FIG. 12 is a view showing another example of the internal program of the robot;

FIG. 13 is a view showing a setting example of the tool center point coordinate system when the position of the rotation axis is changed as the bending process progresses; and

FIG. 14 is a view showing another setting example of the tool center point coordinate system when the position of the rotation axis is changed as the bending process progresses.

### DETAILED DESCRIPTION

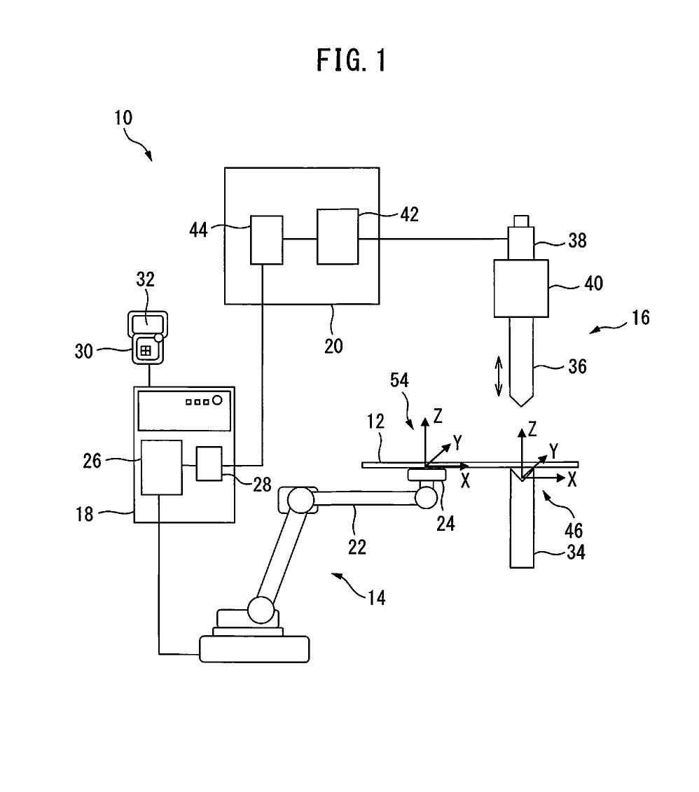

FIG. 1 is a view showing a schematic configuration of a bending process robot system 10 according to a preferred embodiment of the present invention. Bending process robot system 10 includes a robot 14, a bending machine or bender 16, a robot controller 18 for controlling robot 14, and a bender controller 20 for controlling bending machine 16. Robot 14 and bending machine 16 are configured to carry out a bending process with respect to a plate-like workpiece 12 such as a sheet metal.

For example, robot 14 is a multi-joint robot having six axes, and has a robot arm 22 and a robot hand 24 attached to a front end of robot arm 22. Robot hand 24 is configured to hold (for example, grip or adsorb) workpiece 12 so as to supply the workpiece to bending machine 16, and handle workpiece 12 during the bending process of the workpiece.

Robot hand 24 may have an equalizing mechanism for absorbing a positional error of workpiece 12 held by hand 24. In order to precisely control the positional relationship between hand 24 and workpiece 12, hand 24 may hold workpiece 12 after workpiece 12 is positioned on a positioning jig, etc. Alternatively, the position of a portion of workpiece 12 gripped by hand 24 may be detected by a vision sensor, etc., after hand 24 holds workpiece 12, and then the bending process may be carried out after the positional error between the gripped position and a predetermined reference position is corrected.

Although workpiece 12 is one sheet metal in this embodiment, workpiece 12 may have another shape or constitution as long as workpiece 12 can be bent by the robot system of the present invention. Workpiece 12 may be sterically formed by being bent several times by bending machine 16.

Robot controller 18 has a robot controlling part 26 which controls the motion of robot 14 (concretely, a driving part such as a servomotor for driving each axis of robot 14), and a robot communicating part 28 capable of communicating with bender controller 20. Further, a teaching pendant 30 may be connected to robot controller 18, whereby an operator can operate teaching pendant 30 so as to display a control program of robot 14 on a screen 32 of teaching pendant 30; edit the control program; input a motion command to robot controller 18; and/or set or define a user coordinate system as explained below.

Bending machine 16 has a fixed processing knife (a die or lower mold) 34, a second processing knife (a punch or upper mold) 36 movable toward or away from die 34, a pressurized axis motor 38, and a pressurized axis driving part 40 which converts a rotational motion of pressurized axis motor 38 to a linear motion. Bending machine 16 is configured to carry out the bending process with respect to workpiece 12 by nipping and pressurize workpiece 12 between die 34 and punch 36. Bender controller 20 has a bender controlling part 42 which controls the motion of bending machine 16 (concretely, pressurized axis motor 38 for moving punch 36 in the vertical direction), and a bender communicating part 44 capable of communicating with (robot communicating part 28 of) robot controller 18. Due to the communication between robot communicating part 28 and bender communicating part 44, a timing of initiation of movement of (hand 24 of) robot 14 and a timing of initiation of bending motion (contacting between punch 36 and workpiece 12) of bending machine 16 can be matched, whereby robot 14 can be operated in synchronization with bending machine 16 (i.e., a synchronous control between robot 14 and bending machine 16 can be carried out).

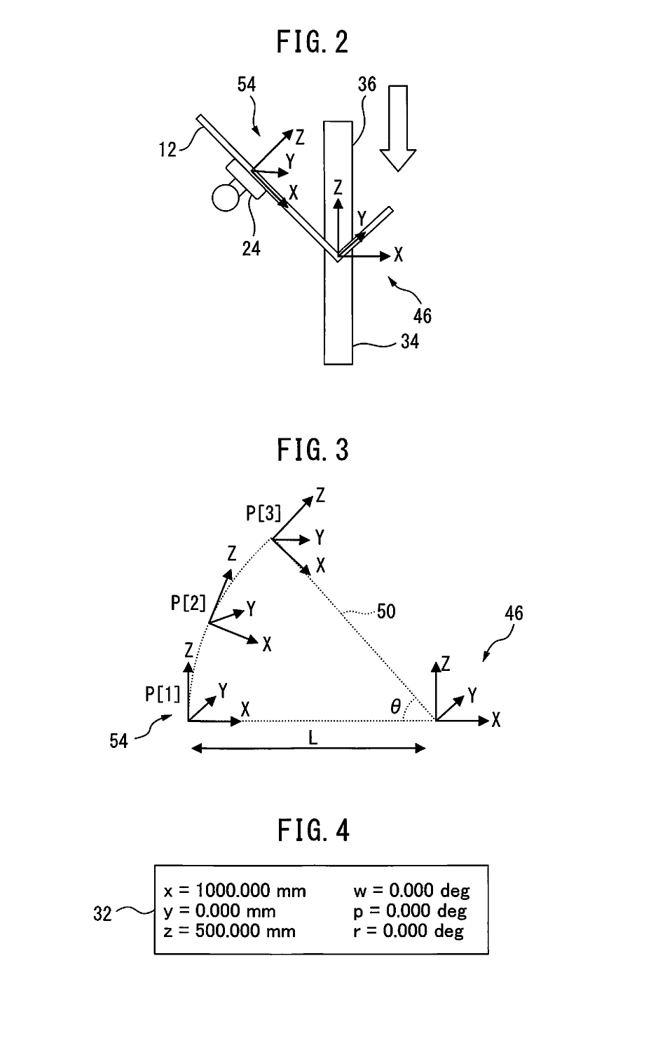

By virtue of the above configuration, in bending process robot system 10, workpiece 12 is held by robot hand 24 and supplied to bending machine 16 so that workpiece 12 contacts die 34 of bending machine 16. Then, during punch 36 of bending machine 16 pressurizes and bends workpiece 12, robot hand 24 holding workpiece 12 carries out an arc motion as the workpiece is deformed, as shown in FIG. 2. Hereinafter, a detail thereof will be explained.

### FIRST WORKING EXAMPLE

First, as shown in FIG. 1 or 3, a user coordinate system 46 is set or determined so as to specify a rotation axis (or a center line of rotation) of the bending motion in the bending process. For example, user coordinate system 46 may be set by inputting the position and/or angle of each axis of robot 14 to teaching pendant 30 by the operator, as exemplified in FIG. 4 (screen 32 of teaching pendant 30). In addition, in the example of FIG. 1, user coordinate system 46 is set so that the Y-axis thereof coincides with an edge of die 34 (in FIG. 1, the Y-axis extends perpendicular to the drawing sheet).

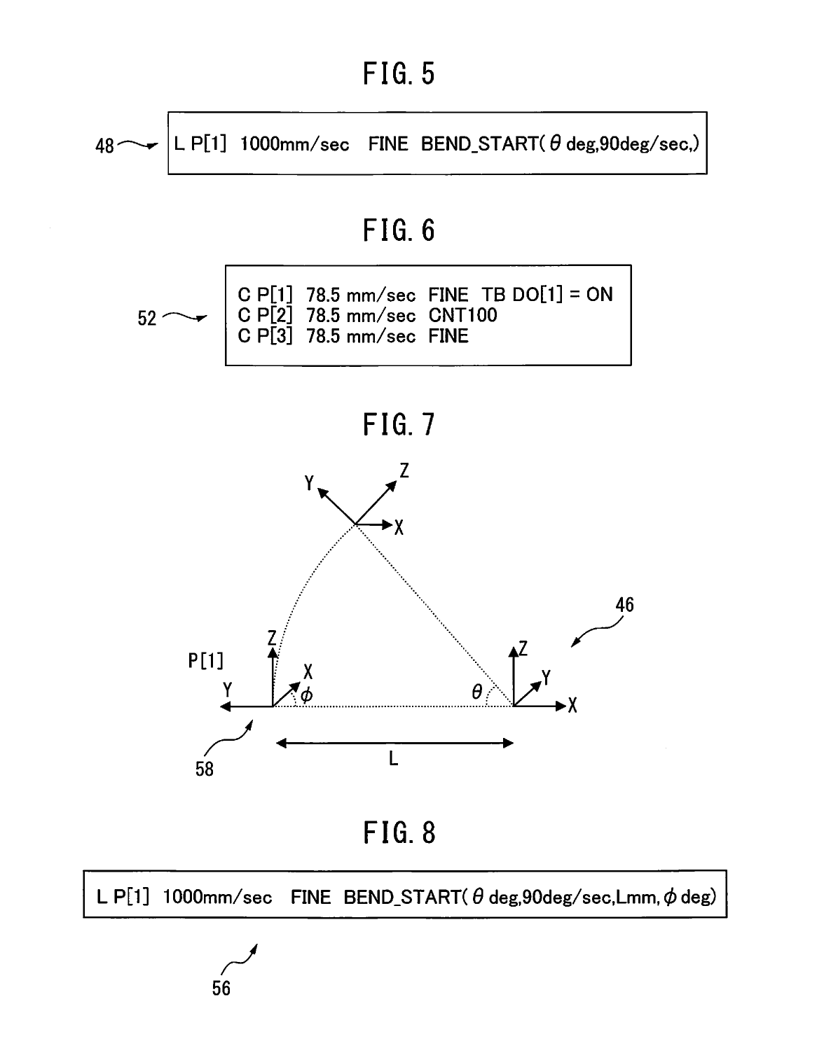

Next, as shown in FIG. 5, in a teaching program 48 of robot 14, a process start position P[1] and an operation form are defined so as to add a bending process command (BEND_START), and a rotation angle (θ) of the bending process (bending motion) and an angular velocity of a command line 50 about the rotation axis (in this case, 90 deg/sec) are designated. By virtue of this, an internal program 52 (FIG. 6) for carrying out an arc interpolation motion as shown in FIG. 3 by robot 14 is generated in robot controlling part 26.

In this regard, process start position P[1] refers to a portion of workpiece 12 held by robot 14. For example, by carrying out a touch-up operation with respect to die 34 during robot 14 holds workpiece 12, process start position P[1] can be taught in robot teaching program 48. By calculating or determining process start position P[1], a tool center point (TCP) coordinate system 54, representing the position and orientation of the front end (in this case, hand 24) of robot 14, is defined, as shown in FIG. 1 or 3. In the example of FIG. 1, TCP coordinate system 54 is specified so that an X-Y plane thereof coincides with a (lower) surface of workpiece 12 which contacts die (or lower mold) 34.

Robot controlling part 26 controls robot 14 so that robot 14 carries out the arc interpolation motion based on generated internal program 52. Concretely, based on taught process start point P[1], the command line velocity (in this case, 90 deg/sec) and the command rotation angle (θ), robot controlling part 26 moves (rotates) TCP coordinate system 54 about the rotation axis (in this case, the Y-axis of user coordinate system 46) from the process start point at the command line velocity by the command rotation angle. Further, robot controlling port 26 transmits a signal command to bender controller 20 via robot communicating part 28, simultaneously with the initiation of the motion of robot 14, in order to operate robot 14 in synchronization with bending machine 16.

In the first working example, a straight line corresponding to an edge of die 34 of bending machine 16 is previously defined as the rotation axis on user coordinate system 46. Further, for example, by carrying out a touch-up operation with respect to die 34 during robot 14 grips workpiece 12 so as to teach a target motion position in the teaching program, and by designating the rotation angle and the command line velocity about the rotation axis with a command for carrying out the bending process to the teaching program, a trajectory of the arc interpolation motion of robot 14 can be generated in robot controlling part 26 and robot 14 can be operated based on the trajectory.

In other words, in the first working example, by teaching the start position of the bending motion in the robot teaching program and by defining the rotation angle and the command line velocity of the bending process, the arc interpolation motion of robot 14, following the arc motion of workpiece 12 about the edge of die 34 during the bending process, can be precisely taught, even if the operator does not designate an end point and an intermediate point of the arc.

### SECOND WORKING EXAMPLE

First, as shown in FIG. 1 or 7, user coordinate system 46 is set or determined so as to specify the rotation axis (or the center line of rotation) of the bending motion in the bending process. For example, similarly to the first working example, user coordinate system 46 may be set by inputting the position and/or angle of each axis of robot 14 to teaching pendant 30 by the operator, as exemplified in FIG. 4 (screen 32 of teaching pendant 30). In addition, in the example of FIG. 1, user coordinate system 46 is set so that the Y-axis thereof coincides with the edge of die 34 (in FIG. 1, the Y-axis extends perpendicular to the drawing sheet).

Next, as shown in FIG. 8, in a teaching program 56 of robot 14, by designating a rotation angle (θ) of the bending process (bending motion), an angular velocity of command line 50 about the rotation axis (in this case, 90 deg/sec), a radius (L) of the bending motion in the X-direction of user coordinate system 46, and a rotation angle (φ) about the Z-axis, a tool center point (TCP) coordinate system 58, representing the position and orientation of the front end (in this case, hand 24) of robot 14, is defined. Further, a process start position P[1] and an operation form are defined so as to add a bending process command (BEND_START) to teaching program 56, whereby internal program 52 (FIG. 6) for carrying out an arc interpolation motion as shown in FIG. 7 by robot 14 is generated in robot controlling part 26.

In this regard, process start position P[1] refers to the portion of workpiece 12 held by robot 14. As shown in FIG. 7, TCP coordinate system 58 representing process start position P[1] can be defined based on user coordinate system 46, radius L and rotation angle φ as explained above, and thus process start position P[1] in teaching program 56 may be a provisional position determined by the dimension of workpiece 12, etc. TCP coordinate system 58 is specified so that an X-Y plane thereof coincides with a (lower) surface of workpiece 12 which contacts die (or lower mold) 34. By changing rotation angle φ, different regions of workpiece 12 can be bent while holding the same portion of workpiece 12 by hand 24.

Robot controlling part 26 controls robot 14 so that robot 14 carries out the arc interpolation motion based on generated internal program 52. Concretely, based on distance L from TCP coordinate system 58 at process start point P[1] to the rotation axis, inclination (angle) φ of TCP coordinate system 58, the command line velocity (in this case, 90 deg/sec) and the command rotation angle (θ), robot controlling part 26 moves (rotates) TCP coordinate system 58 about the rotation axis from the process start point at the command line velocity by the command rotation angle. Further, robot controlling port 26 transmits a signal command to bender controller 20 via robot communicating part 28, simultaneously with the initiation of the motion of robot 14, in order to operate robot 14 in synchronization with bending machine 16.

In other words, in the second working example, the distance of TCP coordinate system 58 on workpiece 12 from the reference position and the inclination component of TCP coordinate system 58 (which are calculated based on design information of the bending process) are defined, and the rotation angle and the command line velocity of the bending process are defined. By virtue of this, the arc interpolation motion of robot 14, following the arc motion of workpiece 12 about the edge of die 34 during the bending process, can be precisely taught, even if the operator does not designate an end point and an intermediate point of the arc.

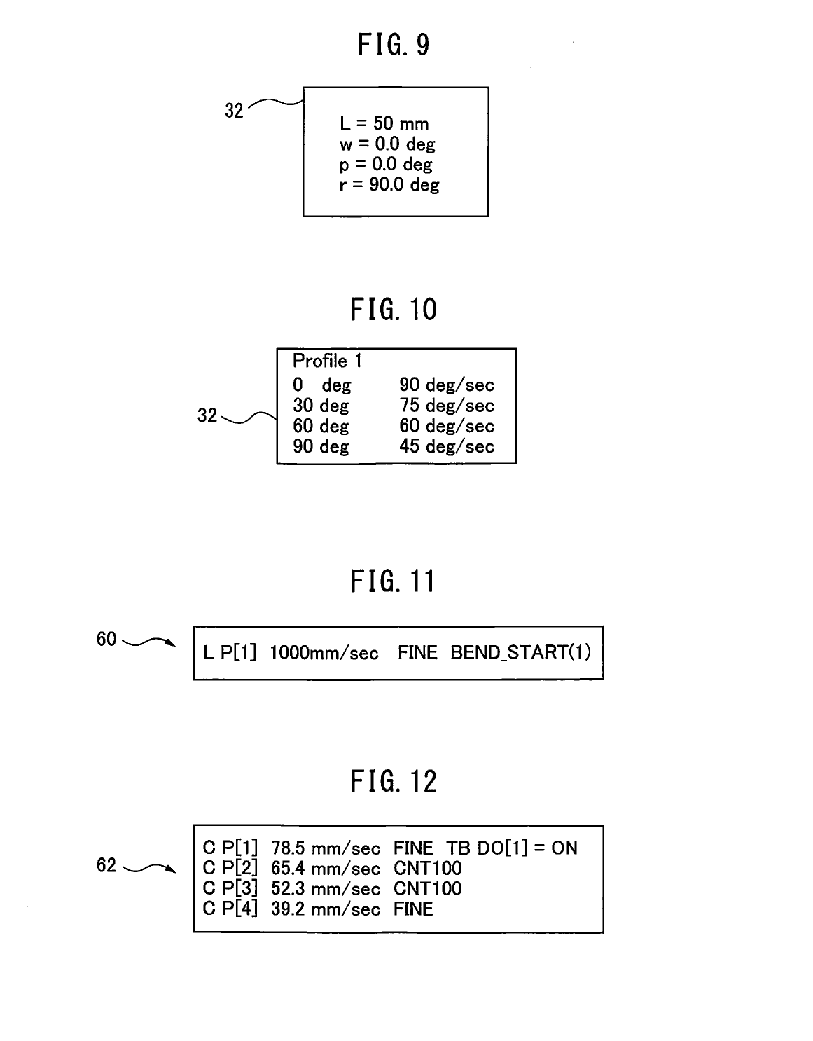

In addition, in the first and second working examples, as exemplified in FIG. 9, the distance (L) between a predetermined point (for example, the origin) of the TCP coordinate system of robot 14 and the rotation axis, and angular components (w, p, r) of a reference vector of the TCP coordinate system may be displayed on screen 32 of teaching pendant 30 in real-time, or may be output to the outside as a signal in real-time. By virtue of this, the robot position regarding the bending process can be displayed or output in real-time during teaching of the process start position, and the positional information of robot 14 during teaching can be checked against process design information of workpiece 12 in real-time. Therefore, the programming of robot 14 can be carried out while adjusting the process start position of workpiece 12.

### THIRD WORKING EXAMPLE

First, as shown in FIG. 8, in teaching program 56 of robot 14, a rotation angle (θ) of the bending process (bending motion), an angular velocity of command line 50 about the rotation axis (in this case, 90 deg/sec), a radius (L) of the bending motion in the X-direction of user coordinate system 46, and a rotation angle (φ) about the Z-axis of user coordinate system 46 are designated. In this regard, similarly to the first working example, process start position P[1] refers to a portion of workpiece 12 held by robot 14. For example, by carrying out a touch-up operation with respect to die 34 during robot 14 holds workpiece 12, process start position P[1] can be taught in robot teaching program 48.

Due to the above procedure, user coordinate system 46 is set or determined so as to specify the rotation axis (or the center line of rotation) in the bending process, as shown in FIG. 7. Further, a process start position P[1] and an operation form are defined so as to add a bending process command (BEND_START) to teaching program 56, whereby internal program 52 (FIG. 6) for carrying out an arc interpolation motion as shown in FIG. 7 by robot 14 is generated in robot controlling part 26.

Robot controlling part 26 controls robot 14 so that robot 14 carries out the arc interpolation motion based on generated internal program 52. Concretely, based on taught process start point P[1], distance L from TCP coordinate system 58 at the process start point to the rotation axis, inclination (angle) φ of TCP coordinate system 58, the command line velocity (in this case, 90 deg/sec) and the command rotation angle (θ), robot controlling part 26 moves (rotates) TCP coordinate system 58 about the rotation axis from the process start point at the command line velocity by the command rotation angle. Further, robot controlling port 26 transmits a signal command to bender controller 20 via robot communicating part 28, simultaneously with the initiation of the motion of robot 14, in order to operate robot 14 in synchronization with bending machine 16.

In the third working example, a touch-up operation is carried out with respect to die 34 during robot 14 grips workpiece 12 so as to teach a target motion position in the teaching program, the radius of the rotational trajectory of root 14 and the inclination of the rotation axis are designated based on design information of workpiece 12 so as to define the rotation axis, and the rotation angle and the command line velocity about the rotation axis are designed by adding a command for carrying out the bending process to the teaching program. By virtue of this, a trajectory of the arc interpolation motion of robot 14 can be generated in robot controlling part 26 and robot 14 can be operated based on the trajectory.

In other words, in the third working example, even when the operator does not define the rotation axis on user coordinate system 46 by inputting operation as shown in FIG. 4, the arc interpolation motion of robot 14, following the arc motion of workpiece 12 about the edge of die 34 during the bending process, can be precisely taught, without designating an end point and an intermediate point of the arc by the operator, by carrying out the touch-up operation with respect to die 34 during robot 14 holds workpiece 12 so as to teach the process start position in the robot teaching program, and by defining the radius of the rotational trajectory of root 14, the inclination of the rotation axis on a plane of workpiece 12, and the angle and the velocity of the bending process based on design information of workpiece 12.

In the above first, second and third working examples, the operator can set or specify a target rotation angle about the rotation axis (the Y-axis of user coordinate system 46) as exemplified in FIG. 3 and an angular velocity until reaching the target rotation angle as a profile. FIG. 10 shows a setting example of the profile (screen 32 of teaching pendant 30). The specified profile may be stored in a suitable memory (or a storing part) provided to robot controller 18 or teaching pendant 30.

Next, as shown in FIG. 11, in a teaching program 60 of robot 14, a process start position P[1] and an operation form are defined so as to add a bending process command (BEND_START), and a stored profile number (in this case, “1”) is designated. By virtue of this, an internal program 62 (FIG. 12) for carrying out an arc interpolation motion by robot 14 is generated in robot controlling part 26.

Robot controlling part 26 controls robot 14 so that robot 14 carries out the arc interpolation motion based on generated internal program 62. Further, robot controlling port 26 transmits a signal command to bender controller 20 via robot communicating part 28, simultaneously with the initiation of the motion of robot 14, in order to operate robot 14 in synchronization with bending machine 16. As such, by storing the velocity transition of robot 14 during the bending process as profile data, so that the profile data can be designated from teaching program 60, the arc interpolation motion can be precisely carried out even when it is necessary to vary the velocity of robot 14 during the bending process based on the shape, etc., of the punch or die of bending machine 16.

In the above first, second and third working examples, information on the velocity of pressurized axis driving part 40 can be transmitted from bender controlling part 42 as shown in FIG. 1 to robot controlling part 26 as an external signal, and robot controlling part 26 can adjust an override of the velocity of robot 14 in real-time by comparing the external signal to a reference velocity. Otherwise, information on an amount of movement of pressurized axis driving part 40, calculated by an integrated value of the velocity, may be transmitted to robot controlling part 26 as an external signal. In this case, robot controlling part 26 can adjust the velocity of robot 14 in real-time based on a relationship between a predetermined amount of movement of pressurized axis driving part 40 and the amount of movement of robot 14. By virtue of this, a following velocity of robot 14, previously designated corresponding to the processing velocity of bending machine 16, can be appropriately adjusted. Further, when bending machine 16 is to be operated at low speed in a test mode, robot 14 can be appropriately controlled.

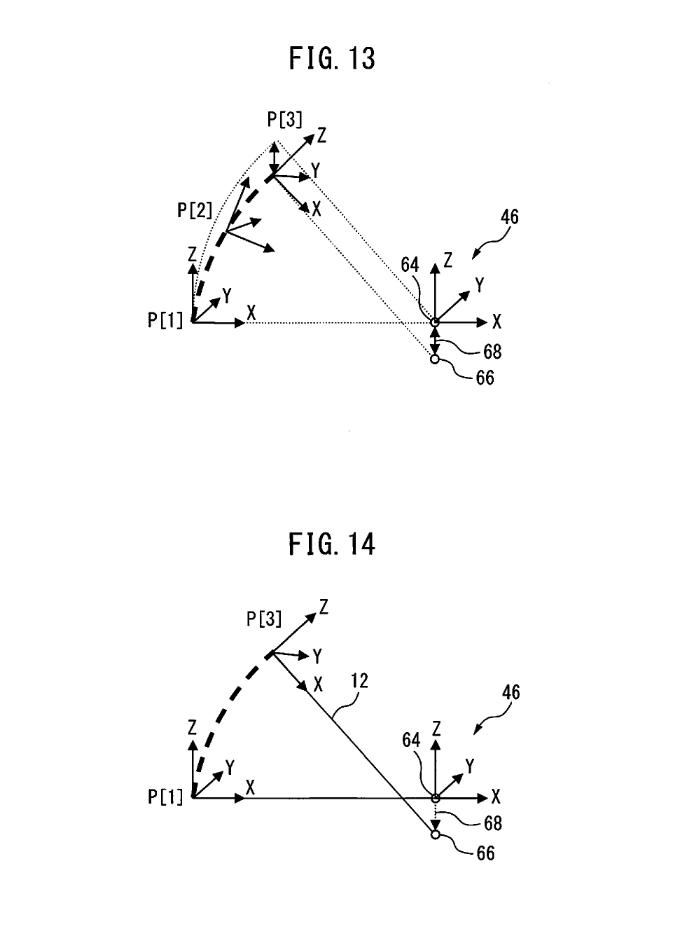

In the above first, second and third working examples, depending on the shape of die 34 or punch 36, the position of the rotation axis (in the illustrated example, the Y-axis of user coordinate system 46) may be moved or changed (in the illustrated example, moved downward in the vertical direction) between when the bending process of workpiece 12 is started (P[1]) and is terminated (P[3]). Therefore, as shown in FIG. 13, it is preferable that a position 64 of the rotation axis when the bending process is started and a position 66 of the rotation axis when the rotation is terminated be previously defined, and the interpolation motion be carried out while a motion component of the rotation axis in the movement direction thereof is added to the arc interpolation motion about the rotation axis when the bending process (or the rotation) is started.

Otherwise, as shown in FIG. 14, when position P[3] at the time when the bending process (or the rotation) is terminated is taught, workpiece 12 may be offset from the position of the rotation axis on user coordinate system 46 at the time when the bending process by a motion component (in the illustrated example, a Z-component 68) in the movement direction of the rotation axis. In this case, the effect substantially equivalent to the example of FIG. 13 can be obtained, by teaching two points (i.e., rotation start position P[1] and rotation end position P[3]), by calculating respective conversion matrixes from the TCP coordinate system to the user coordinate system at the rotation start position and the rotation end position, by calculating respective incremental matrixes by gradually changing elements of the conversion matrixes, and by carrying out interpolation control with respect to the TCP coordinate system while carrying out reverse conversion based on the conversion matrixes and the incremental matrixes. In this regard, a method regarding the conversion matrix and the reverse conversion is well-known, as described in JP S63-268005 A, etc.

As shown in FIG. 13 or 14, even when the movement trajectory of robot 14 holding workpiece 12 during the bending process is not a precise arc, the following motion of robot 14 can be smoothly carried out without applying an inappropriate force to workpiece 12, by moving the rotation axis in the bending process corresponding to the movement of the contact point between workpiece 12 and die 34 or punch 36 of bending machine 16.

In the embodiment of FIG. 1, by providing the equalizing mechanism to robot hand 24, the bending process carried out without applying an inappropriate force to workpiece 12, even when the movement trajectory of robot 14 required to follow the bending process is not a precise arc, or when the timing of synchronization between bending machine 16 and robot 14 is off.

In addition, in the embodiment of FIG. 1, an additional axis of robot 14 may be used as pressurized axis driving part 40 for moving punch 36. In this case, since the additional axis can be controlled by robot controller 18, bender controller 20 is not necessary, whereby robot system 10 may be constituted at low cost.

Further, since it is not necessary to consider a delay time of the communication between robot controller 18 and bender controller 20, the synchronization motion between robot 14 and bending machine 16 can be precisely carried out.

According to the present invention, the arc interpolation motion of the robot for following the rotational motion of the workpiece during the bending process can be easily and precisely taught, even if the operator does not designate the end point and the intermediate point of the arc.

While the invention has been described with reference to specific embodiments chosen for the purpose of illustration, it should be apparent that numerous modifications could be made thereto, by a person skilled in the art, without departing from the basic concept and scope of the invention.

1. A robot system comprising:
a robot having a hand for holding a plate-like workpiece; and
a bending machine for carrying out a bending process with respect to the workpiece while the workpiece is held by the hand,
wherein a rotation axis of a bending motion in the bending process and a tool center point coordinate system of a front end of the robot are previously defined in a robot controller for controlling the robot,
wherein, based on a taught process start point, a command line velocity and a command rotation angle, the robot controller moves the tool center point coordinate system from the process start point at the command line velocity about the rotation axis by the command rotation angle, and
wherein the robot controller and a bender controller for controlling the bending machine match a timing of initiation of movement of the tool center point coordinate system and a timing of initiation of bending motion of the bending machine, so as to carry out a synchronous control between the robot and the bending machine.

2. The robot system as set forth in claim 1, wherein a distance from the tool center point coordinate system to the rotation axis and an angular component of a reference vector of the tool center point coordinate system are displayed in real-time or output to the outside as a signal in real-time, by the robot controller.

3. The robot system as set forth in claim 1, wherein a velocity transition of the robot during the bending process is stored as profile data, and the profile data is designated from a teaching program of the robot.

4. The robot system as set forth in claim 1, wherein information on a velocity or an amount of movement of the bending machine is transmitted to the robot controller as an external signal, and the robot controller adjusts the velocity of the robot in real-time based on the external signal.

5. The robot system as set forth in claim 1, wherein a motion component of the rotation axis in a movement direction thereof is added to an arc interpolation motion of the robot about the rotation axis.

6. The robot system as set forth in claim 1, wherein the hand of the robot has an equalizing mechanism.

7. The robot system as set forth in claim 1, wherein the robot has an additional axis used as a pressurized axis driving part of the bending machine.

8. A robot system comprising:
a robot having a hand for holding a plate-like workpiece; and
a bending machine for carrying out a bending process with respect to the workpiece while the workpiece is held by the hand,
wherein a rotation axis of a bending motion in the bending process and a tool center point coordinate system of a front end of the robot are previously defined in a robot controller for controlling the robot,
wherein, based on a distance from the tool center point coordinate system at a process start point to the rotation axis, an inclination of the tool center point coordinate system, a command line velocity and a command rotation angle, the robot controller moves the tool center point coordinate system from the process start point at the command line velocity about the rotation axis by the command rotation angle, and
wherein the robot controller and a bender controller for controlling the bending machine match a timing of initiation of movement of the tool center point coordinate system and a timing of initiation of bending motion of the bending machine, so as to carry out a synchronous control between the robot and the bending machine.

9. The robot system as set forth in claim 8, wherein a distance from the tool center point coordinate system to the rotation axis and an angular component of a reference vector of the tool center point coordinate system are displayed in real-time or output to the outside as a signal in real-time, by the robot controller.

10. The robot system as set forth in claim 8, wherein a velocity transition of the robot during the bending process is stored as profile data, and the profile data is designated from a teaching program of the robot.

11. The robot system as set forth in claim 8, wherein information on a velocity or an amount of movement of the bending machine is transmitted to the robot controller as an external signal, and the robot controller adjusts the velocity of the robot in real-time based on the external signal.

12. The robot system as set forth in claim 8, wherein a motion component of the rotation axis in a movement direction thereof is added to an arc interpolation motion of the robot about the rotation axis.

13. The robot system as set forth in claim 8, wherein the hand of the robot has an equalizing mechanism.

14. The robot system as set forth in claim 8, wherein the robot has an additional axis used as a pressurized axis driving part of the bending machine.

15. A robot system comprising:
a robot having a hand for holding a plate-like workpiece; and
a bending machine for carrying out a bending process with respect to the workpiece while the workpiece is held by the hand,
wherein a tool center point coordinate system of a front end of the robot is previously defined in a robot controller for controlling the robot,
wherein, based on a taught process start point, a command line velocity, a command rotation angle, a distance from the tool center point coordinate system at the process start point to a rotation axis of a bending motion in the bending process and an inclination of the tool center point coordinate system, the robot controller moves the tool center point coordinate system from the process start point at the command line velocity about the rotation axis by the command rotation angle, and
wherein the robot controller and a bender controller for controlling the bending machine match a timing of initiation of movement of the tool center point coordinate system and a timing of initiation of bending motion of the bending machine, so as to carry out a synchronous control between the robot and the bending machine.

16. The robot system as set forth in claim 15, wherein a velocity transition of the robot during the bending process is stored as profile data, and the profile data is designated from a teaching program of the robot.

17. The robot system as set forth in claim 15, wherein information on a velocity or an amount of movement of the bending machine is transmitted to the robot controller as an external signal, and the robot controller adjusts the velocity of the robot in real-time based on the external signal.

18. The robot system as set forth in claim 15, wherein a motion component of the rotation axis in a movement direction thereof is added to an arc interpolation motion of the robot about the rotation axis.

19. The robot system as set forth in claim 15, wherein the hand of the robot has an equalizing mechanism.

20. The robot system as set forth in claim 15, wherein the robot has an additional axis used as a pressurized axis driving part of the bending machine.
